(19) United States
(12) Patent Application Publication
(10) Pub. No.: US 2011/0250432 A1
(43) Pub. Date: Oct. 13, 2011

(54) OPEN-PORE FORMED BODY AND METHOD FOR THE PRODUCTION THEREOF

(75) Inventor: Hans-Peter Kohlstadt, Velbert (DE)

(73) Assignee: Dennert Poraver GmbH, Postbauer-Heng (DE)

(21) Appl. No.: 13/141,022

(22) PCT Filed: Dec. 3, 2009
(86) PCT No.: PCT/EP2009/008623

§ 371 Date: Jun. 20, 2011

(30) Foreign Application Priority Data
Dec. 19, 2008 (DE) 10 2008 063 815.3
Mar. 5, 2009 (DE) 10 2009 011 263.4

(51) Int. Cl. B32B 3/26; C08L 75/04; B29C 43/50; C08G 18/32

(52) U.S. Cl. 428/312.6; 525/460; 524/590; 264/48

(57) ABSTRACT

An open-pore formed body based on inorganic, partially open-pore light granulates is based on at least one material from the group of alkali silicates, alkali-alkali earth silicates, aluminosilicates, borosilicates, and variants in the three material system CaO—SiO₂—Al₂O₃ in combination with additional metal oxides such as TiO₂ FeO₃ Mn₂O₃. It has a bulk density of 0.10 to 0.60 kg/dm³ measured according to DIN EN 1097-3, wherein the light granulate is provided with a hydrophobised surface and is bound with an organic binding agent to form the formed body.

The invention relates to an open-pore formed body based on inorganic, partially open-pore granulates and organic binding agents and the production thereof.

Formed bodies of this type have been known for decades. A self-supporting, resilient and compressible adsorption filter layer made of a highly air-permeable carrier material and of an adsorption agent fixed by an adhesive compound is described in DE 195 21 666 A1. Any large-pore foam, in particular a reticulated polyurethane foam can be used as the carrier material. Organic, cross-linkable polymers, such as, for example, polyurethane adhesives can be used as the adhesive compound. Hydrophobic molecular sieves can be used inter alia as the adsorption agent. In many cases, a compressible formed body is disadvantageous and a dimensionally stable formed body with a certain compressive strength is necessary.

DE 102 41 978 A1 describes a non-combustible, moisture-regulating and sound-absorbing formed body made of a mineral foam granulate and/or foam glass and/or expanding mineral and a non-combustible, inorganic binding agent, in particular calcium sulphate. The density is about 400 g/l, including glass nonwoven on the upper and lower side.

DD 231 338 B1 describes a fire resistant, sound-insulating formed bodies made of a porous granulate, conventional binding agents and water-soluble fine particles with an acicular, rod-shaped or fibrous form and with specific lengths and widths. The density is 1.14 g/cm³. Hydrophobising of the porous granulate is to become superfluous owing to the fine particles.

A water-permeable stone composite formed body made of 1 to 35% by weight reactive polyurethane adhesives or polyurethane casting compounds together with 99 to 65% by weight of granulates made of mineral materials or plastics materials, forming stable panels and formed bodies is described in DE 10 2007 012973 A1. Stones, gravel, ballast, coarse sand, chippings, ceramics, glass and plastics material granulates are disclosed as the granulates, for example. No mention is made of porous and coated granulates, in particular light granulates with a hydrophobised surface. The 2-component polyurethane adhesive is a mixture of the polyol and the isocyanate component. The polyol component contains inter alia
10 to 98% by weight of at least one oleochemical polyol,
1 to 20% by weight of a dry oil, for example linseed oil, and
0 to 75% by weight of auxiliaries, inter alia hollow balls.

The hardening takes place between 5 and 80° C. The high weight of the formed bodies because of the compact fillers is disadvantageous inter alia. It can only be slightly reduced by adding hollow balls as auxiliaries of the polyurethane adhesive.

EP 1 541 605 A2 describes panels and formed bodies based on polyurethane binding agents made of at least one polyisocyanate, polyols, long-chain fatty acids, optionally water and amines with fillers, wherein expanded clay, foam glass, foam ceramics, ceramic or glass hollow balls or their mixtures being mentioned inter alia. The fillers should have a round or oval or completely irregular structure. No mention is made of open-pore coated fillers. The ratio of binding agents to fillers should be between 0.5:9.5 and 5:5, it being unclear whether these are volume or weight fractions. Even with a low binding agent content, panels or semi-finished products with a high strength and high flexibility are to be achieved. The hardening takes place at a pressure of 1 MPa to 40 MPa and at temperatures of 60° C. to 180° C. for 1 to 30 min in closed moulds. The drawback above all is that neither the fillers nor the formed body itself is notably porous and therefore allows practically no water through.

DE 195 20 367 A1 describes a light filter, in which foam glass is bound by polyurethane binding agents, in which the quantity ratio of foam glass: polyurethane binding agent is to be less than 5:1, in particular less than 3:1. A foam glass is taken to mean a solidified glass foam with cells closed in an air-tight manner, which are filled with glass. It is present in round, preferably spherical particles. In the example, glass particles from Dennert Poraver are used. No mention is made of hydrophobised foam glass. The polyhydroxy polyethers known per se and all multivalent aromatic and aliphatic isocyanates are, in particular, possibilities for producing the polyurethane adhesive. In general, 1 to 12% by weight based on the polyol, for a “thickening of aluminosilicates”, preferably an absorber paste based on caster oil, is used to produce filters with a high water through-flow rate, whereby the moisture in the polyurethane components is to be made harmless. The hardening takes place at temperatures of more than 120° C. A drawback inter alia is the high content of polyurethane binding agent and therefore the increased expense of the filters.

DE 2006 000 751 U1 describes a formed body made of a) plastics materials with at least a 50% by weight fraction of polyester, epoxide, polystyrene, polyurethane and/or polyamide, b) light mineral additives and c) renewable raw materials. In the example, 30% by weight of powder coating residues, 20% by weight of recycled glass balls (Poraver®) and 20% by weight seaweed are bound to 30% by weight of the two-component adhesive (Henkel-Ubatol UK 820) at 20° C. in about 10 minutes. The drawback, inter alia, is in turn the high fraction of adhesives and therefore, accompanying this, the lack of water-permeability and the high price of the formed bodies.

EP 1 188 730 A2 describes plastics material-bound, sealed-structure light construction materials made of a mineral foamed granulate and an organic binding agent, the volume fraction of the light granulate in the material being at least 50%, preferably at least 90%. The light granulates either have closed pores or, in particular applications, have an only slightly open surface porosity in the range from 1 to 10% based on the total volume. The infiltratability of the grain by the binding agent is limited by this porosity. Poraver is mentioned inter alia as the light granulates. No mention is made of hydrophobised granulates. The suitable binding agents include the thermosetting materials, for example epoxy resin, polyurethane, phenolic resin, unsaturated polyesters and silicone resin. The object of developing economical light construction materials is achieved by a high packing density because of the mixture of light granulates, which are as uniform as possible and spherical, with, for example, three different grain size groups, the necessity for relatively expensive binding agents being reduced. The drawback inter alia, is that the light construction material has a sealed structure, in other words is water-impermeable and has a density of more than 400 kg/m³.

The object according to the invention is to completely or partially eliminate the drawbacks of the teachings of the cited documents, in particular, therefore, an open-pore formed body with a low density and a particularly low adhesive fraction is to be provided, but without a reduction in the strength, in particular the flexural strength. The low adhesive fraction results in low production costs and, generally, also favourable fire behaviour. The open-pore nature of the formed body is accompanied by high water-permeability and special acoustic behaviour.

The solution according to the invention is to be inferred from the claims. It substantially consists in that the surface of porous light granulates is treated in such a way that the binding agent does not penetrate into the porous light granulate and is therefore no longer available for its actual task, namely to bind the granulate. It was not to be expected that this would be possible by hydrophobising with a hydrophobic liquid, in particular with an oil, without the strength being drastically reduced thereby, as the preparation of an adhesion per se includes drying the surfaces and making them grease-free. Moreover, it was to be feared that the strength would be reduced because the surface of the light granulate is equalised by the hydrophobising agent and therefore the interconnection with the adhesive is reduced or even prevented. The invention thus consists of an open-pore formed body based on inorganic light granulates with a hydrophobised surface and organic binding agents.

The light granulate should as far as possible be round, in particular virtually spherical. It has an uneven and crevassed surface, as can be produced by sintering. The light granulate has a grain size between 0.01 and 30 mm, preferably between 0.04 and 16 mm and particularly preferably between 0.1 and 8 mm. The formed body preferably contains a light granulate from a single or from two to four different grain size groups, each grain size group being as uniform as possible. The grain size is determined in that a weighed out particle quantity is sieved with a sieve set with a mesh size of 11, 8, 5, 4, 3, 2 and 1 mm and the fractions obtained are weighed. The weight of these sieve through fractions is in each case related to the total quantity and thus produces the fraction of the respective through fraction in weight %. If the sieve through fractions are applied in % by weight depending on the mesh size, the grain size is obtained in the form of the particle size distribution curve. If, for example, a sieve set with mesh sizes of 5, 2 and 1 mm is used, individual fractions of >5, 5-2, 2-1 and <1 mm are obtained. If 1000 g particles are sieved and fractions of 10, 500, 430 and 60 g in weight are obtained, the sieve through fraction is 1.0, 50.0, 43.0 and 6.0% by weight, in each case in the order of the fractions mentioned. In the investigations, particles were used, the grain size of which was obtained by sieve through fractions between the disclosed mesh sizes.

The light granulate should have a bulk density of 0.10 to 0.60 kg/dm³, preferably of 0.15 to 0.35 kg/dm³, measured according to DIN EN 1097-3.

For this purpose, after drying at room temperature (about 20° C. and about 50% relative air humidity) to weight constancy, the granulate is poured loosely into a measuring vessel with a 1 litre content and projecting granulate is carefully skimmed off. A differential weighing produces the bulk weight as a quotient of the weight and volume in kg/dm³.

The light granulate is porous and partially open-pore, which can be easily determined by its water absorption according to DIN V 18004: For grain sizes of less than 2 mm, the water is introduced into a suction filter and the surface is dried by suction with a water jet pump. For grain sizes of greater than 2 mm, the water is introduced into a pycnometer and the surface is dried by dabbing off. 100 g of a dried light granulate should absorb up to 40 g water.

The light granulate is made of an inorganic material, based on alkali silicates, alkali-alkali earth silicates, aluminosilicates, borosilicates, and/or variants in the three-material system CaO—SiO₂—Al₂O₃ in conjunction with additional metal oxides such as TiO₂ Fe₂O₃ Mn₂O₃. Spherical light granulates made of foam glass, expanded clay, pumice, mica or a similar material are specifically mentioned. The preferred starting material is foam glass.

The production of a light granulate will be outlined using an example of the foam glass granulate PORAVER® of Dennert Poraver GmbH, Postbauer-Heng (see also DE 103 60 819 A1): Firstly, pure glass is ground into a fine glass powder. The glass powder is mixed with water, binding agent and expanding agent and the mixture in the granulating panel is brought into a round form. The small balls are dried and heated in a rotary furnace to about 900° C. and expanded in the process. This produces a fine-pore round granulate, which encloses fine air chambers in the interior.

After cooling and sieving, a light granulate of the desired grain size ready for sale is obtained.

The following conventional products are more or less usable light granulates: KeraGlas, KeraBims, KeraPlus, KeraLight, Poraver, Liaver, Liapor, Leca and Hollow-Spheres.

The light granulate is hydrophobised, i.e. treated with a hydrophobic liquid in such a way that its pores which are accessible to water are reduced or completely eliminated; it is expediently hydrophobised superficially with a dry oil, which is generally taken to mean a glycerol ester with more than 20% of singly or multiply unsaturated fatty acids. Mentioned in particular are linseed oil, olive-residue oil, hemp seed oil, poppy seed oil, oiticica oil, perilla oil, walnut oil, oil of turpentine, wood oil, caster oil, fish oil and tall oil, but soya bean oil, sunflower oil, rape seed and safflower oil are also mentioned. Unsaturated acids can also be used, for example resin acids, linoleic acid and linolenic acid. The preferred hydrophobising agent is linseed oil. The iodine value of the drying or half-drying oils should expediently be in the range of 100 to 250. To accelerate the drying, drying materials can be added, in particular metallic soaps.

The light granulate should be treated with a quantity of hydrophobising agent such that after a coating with water, significantly less or no water at all is absorbed superficially, for which purpose 1 to 7, in particularly about 5% by weight of hydrophobising agent are generally expediently sufficient. Expediently, the hydrophobising agent is used directly before the production of the formed body. However, it can also already be applied independently thereof significantly earlier to the light granulate, for example weeks or months beforehand.

The binding agent connects similar or different materials to one another. The organic binding agents are predominantly based on polymeric compounds, whether thermoplastics, elastomers, in particular, however, thermosetting materials from the group of reaction adhesives, polyurethane, polyepoxide, unsaturated polyester, phenolic resin or silicone resin. Of these, polyurethane adhesives are particularly significant, whereby adhesives which consist of polyisocyanates, polyols and, generally, auxiliaries such as catalysts, modifying agents and fillers are to be understood. Particularly significant are 2-component polyurethane adhesives, based on polyhydroxy polyethers in the molecular weight range of 60 to 10000, preferably 70 to 6000, with 2 to 10 hydroxyl groups per molecule and on multivalent aromatic and/or aliphatic isocyanates preferably with on average 2 to at most 4 NCO groups per molecule.

A preferred embodiment of the claimed formed body is characterised in that it can be produced with a 2-component polyurethane adhesive as the organic binding agent, as described in DE 10 2007 012 973 A1, to which reference is expressly made, above all to the adhesive described there. This adhesive generally has the following composition:
a) 10 to 98% by weight of at least one oleochemical polyol,
b) 1 to 50% by weight of at least one diol with a molecular weight of 60 to 2000 g/mol,
c) 1 to 10% by weight of at least one trivalent, tetravalent or pentavalent polyol with a molecular weight of 90 to 750 g/mol and
d) 0 to 75% by weight of at least one auxiliary, the % by weight being related in total to the components a) to d) and
e) at least one polyisocyanate, wherein the NCO/OH ratio of the isocyanates to the polyols is 1.0 to 2.0:1.

Oleochemical polyols are taken to mean polyols based on plant and animal oil and fats, the secondary products thereof and petrochemically produced equivalent materials. Mentioned as an important group are the reaction products of epoxidised fatty materials with monofunctional, difunctional or polyfunctional alcohols or glycerol esters of long-chain fatty acids, which are at least partially substituted with hydroxyl groups. Examples of compounds of this type are ring opening products of epoxidised triglycerides, ring opening and re-esterification products of epoxidised fatty acid esters of low alcohols, reaction products of epoxidised fatty alcohols with C₂ to C₈-alcohols and above all caster oil and dimerdiols.

The hydroxyl values of the oleochemical polyols may be in the range from 50 to 400, preferably in the range from 100 to 300. Individual substances or mixtures can be used as diols. The diols have a molecular weight of between 60 and 2000 g/mol. These are above all alkanediols with 2 to 6 C-atoms, it being possible for the alkane to be linear, branched or cyclic.

The adhesive should also contain at least one trifunctional or higher functional polyol. Polyols with 3, 4 or 5 OH-groups are preferred, for example glycerol, trimethylolpropane and trimethylolethane. The molecular weight should be between 90 and 750 g/mol, in particular up to 400.

The polyisocyanate component substantially contains at least one polyisocyanate, above all the known di- and polyisocyanates preferably with on average 2 to at most 5, in particular 2 to 3 NCO groups. Both aromatic and aliphatic polyisocyanates can be used, for example crude MDI or cyclohexane-1,4-diisocyanate. The ratio of the isocyanate groups to the OH-groups is in the range from 1.0:1 to 2.0:1. A slight excess of isocyanate groups is preferred. In particular, the ratio is between 1.02:1 and 1.8:1.

The adhesive may also contain auxiliaries, for example fillers, flow-promoting agents, degassers, thixotropic agents, catalysts, anti-aging agents, UV stabilisers, dyes, solvents, wetting agents, drying agents, and in particular a resin. A resin is liquid to solid amorphous organic products, for which a more or less wide distribution of the relative molar mass is characteristic. Specific examples are the synthetic resins: hydrocarbon, terpene, alkyd, coumarone/indene, furan, aldehyde, ketone and glycerol ester resins. Their quantity may be up to 60%, in particular 2.5 to 40% by weight, based on the polyol component in total.

Molecular sieves are above all suitable as the means for drying the polyol component (drying agent).

A 2-component polyurethane adhesive of the following composition is particularly suitable:

The polyol component is produced from the following components with a fast-running stirrer and degassed:
31,5 parts by weight of caster oil,
parts by weight of a trifunctional polyether polyol (PPG Mₙ 450),
3,2 parts by weight of dipropylene glycol,
4,3 parts by weight of a molecular sieve,
10 parts by weight of a cyclohexanone formaldehyde resin,
41 parts by weight of calcium carbonate (powder) and,
2,0 parts by weight of Aerosil R202.

In order to obtain the reactive adhesive, the polyol component is mixed with 35.5 parts by weight of crude MDI. The adhesive cross-links at conventional ambient conditions (about 20° C. and about 50% relative air humidity), but also at elevated temperature and air humidity, for example at 45° C. and 100% relative air humidity.

A conventional commercial 2-component polyurethane adhesive is, for example, the system UK 8614/CR 4300 from Henkel KGaA.

The organic binding agent is contained in the formed body at less than 50% by weight, in particular in the range from 5 to 20% by weight and quite particularly from 7 to 13% by weight, based on the granulate.

The formed body optionally contains, in special cases, as a further component, a reinforcement, in particular short-fibre or long-fibre reinforcement fibres, grid webbing and nonwovens, above all made of glass, whether in the interior or on one of the two sides. However, because of the high strength, no reinforcement is generally necessary, in particular with a high thickness. A carrier material, for example a coarse porous polyurethane foam, for the light granulate, is also unnecessary.

The density of the formed body is below 1000 kg/m³, preferably below 400 kg/m³ and in particular below 300 kg/m³, preferably in the range from 200 to 400 kg/m³. It is determined by weighing and measuring the height, the width and the depth of a cuboid.

The formed body has a retention volume in the range of 20 to 70%, in particular in the range of 40 to 60, and quite particularly around 50%. The retention volume was determined in that a test body with a precisely measured volume, in particular with a length, width and height of 70 mm (i.e. 343 cm³), in each case, is placed in a precisely defined volume of 1000 cm³ of mains water at 20° C. After 10 minutes, the increase in volume was measured in ml. If the increase in volume determined is related to the starting volume of the test body, the retention volume in % by volume is obtained. If, for example, the starting volume is 343 cm³ and the increase in volume is 213 cm³, the retention volume is calculated in that (343-213) is multiplied by 100 and divided by 343. Thus 40.6% by volume is obtained.

The formed body has a water permeability between 500 and 3000 dm³/(min m²), in particular between 800 and 2400 dm³/(min m²) at a layer thickness of 5 cm. The water permeability was determined in that the quantity of the water which ran through at 20° C. in litres is related to the time in minutes and the surface of the sample in m². This produces the throughflow quantity in litres per m² and minute for the respective panel with the specific thickness thereof.

Despite the extremely low density, the formed body has a high strength, for example a high compressive strength, but in particular a high flexural strength (MOR, most of rupture) of up to 3.0 N/mm², in particular of 0.5 to 1.5 N/mm² according to DIN EN 310.

The formed body, if desired, is partially or over the whole area, whether on one side or all sides on its surface, provided with a different material, for example with a plywood panel, chipboard, oversized chipboard (also OSB boards), hemp panel, with a multi-layer plywood, fibre cement layer, an HPL panel (High Pressure Laminate), a CPL panel (Continuous Pressure Laminate), an HDF panel (High Density Fibre panel), an MDF panel

(Middle Density Fibre panel), in particular, however, with a flexible laminating material such as textile or paper and/or a foil or metal sheet based on an organic or inorganic material such as melamine resin or aluminium. It is particularly recommended to apply at least one silicate coating layer, which is at least 1 mm thick, in particular 1 to 2 mm thick, with a grain size of 0.5 to 2.0 mm, for example made of the non-combustible coating 260 from the company Weber in Wiilfrath, so the formed body becomes flame-resistant according to DIN 4102 B 1. The flame-resistance can be further improved by the addition of liquid flame retardants to the adhesive and/or the light granulate, in particular by halogenated phosphoric acid esters such as, for example, tris(chloropropyl) phosphate (TCPP), tris(dichloroisopropyl) phosphate (TDPP) or the Antiblaze TMCP from the company Albemarle Corporation. The formed body preferably has a geometric form, whether it is that of a compact body such as panels, beams and blocks or whether of a hollow body such as tubes and troughs.

The formed bodies according to the invention are produced by methods which are known per se with regard to their basic concept. However, the new method step of hydrophobising is decisive. This method is also known in another context, for example in painting technology. In general, the formed bodies according to the invention can be produced in that
a) the inorganic light granulate is hydrophobised,
b) the hydrophobised light granulate is mixed with the organic binding agent, preferably the binding agent mixture or with the individual components of the organic binding agent and optionally with auxiliaries, inter alia also with materials which can be dissolved and/or dispersed in the binding agent, in particular with liquid flame-retardants,
c) the granulate/binding agent mixture is shaped and compressed,
d) the compressed granulate/binding agent mixture is hardened and
e) the hardened granulate/binding agent mixture is demoulded.

The isocyanates are generally used with an excess of up to 30%, preferably 10 to 25% of isocyanate based on the polyol.

The individual components of the organic binding agent are preferably mixed with the hydrophobised granulate, specifically in the following order: polyols, polyisocyanates or polyepoxides and auxiliaries.

It is particularly favourable for the wetting, if the organic binding agent has a viscosity of 1000 to 20 000 mPas at the application temperature, preferably at 15 to 50° C., measured according to EN ISO 2555. The binding agent is then above all prevented from accumulating at the base of the moulding.

It is recommended to not only bind the light granulate together with the adhesive, but also simultaneously to the laminating material, for example to textiles (for example with glass fibre nonwovens and/or to glass fibre grid webbings) or foils, metal sheets, in that the mouldings are lined with the laminating materials, in particular at the top, bottom and/or in the centre. The laminating materials have to be coated with the binding agent in a quantity of 50 to 300 g/m², expediently with the same binding agent as for binding the light granulate.

It is simplest to obtain the desired formed bodies in a discontinuous production process if the mixture of granulate and binding agent is placed in non-closed mouldings and the uniform filling is assisted by shaking, vibration and/or pressure, the pressure preferably being exerted by rollers using release agents which are commercially conventional for polyurethane adhesives. It is also possible to use petroleum ether in a mixture with oils—for example with linseed oil—as an anti-adhesion agent.

It is expedient to harden the granulate/binding agent which is compressed and formed at a distance in a single press, a multi-press or a continuous press, in particular in a double band press.

In general, the compressed granulate/binding agent is hardened in open mouldings at a pressure of 1 to 40 MPa in a temperature range of more than 0 and less than 100° C., in particular in the range from 5 to 60° C. in 5 minutes to 3 days, in particular in 2 to 3 minutes, until it is handleable; it is preferably fully hardened.

In a particular efficient manner, it is provided according to a preferred method variant to produce the formed body in a continuous process. For this purpose, the light granulate is successively mixed in a mixing device, such as preferably a mixing extruder, with the hydrophobising agent for hydrophobising, the organic binding agent or binding agent mixture is then supplied and the granulate/binding agent mixture is continuously pressed for shaping and compression in a continuous press. The above-mentioned double band press may be used for this purpose. The strand thus produced can be hardened and then separated into the individual formed bodies.

A hot hardening is to be recommended when it is a question of reducing the adhesive additive without the strength suffering thereby. Furthermore, productivity is thereby increased, specifically both during continuous and discontinuous production. The press temperature is in the range of more than 60° C. up to 250° C., preferably in the range from 150 to 250° C. during the hot hardening. At temperatures of more than 60 to 250° C. it lasts about 4 hours to about 2 minutes and at temperatures of between 150 and 200° C., about 10 minutes to 4 minutes. These quantitative details apply to a 2-component polyurethane adhesive with a reactivity as expressed in a pot life from about 2 to about 30 minutes at room temperature, preferably 4, 5 or 6 minutes.

It is economical if the hardened granulate/binding agent mixture is demoulded without cooling and only then completely cured. If desired, a silicate fine coating can also be applied to the hardened formed body, expediently in a 1 to 2 mm layer thickness on at least one side.

The formed bodies according to the invention are distinguished compared to formed bodies without hydrophobising of the light granulates by significant properties:
significantly less adhesive can be used without the strength thereby suffering. In the example, only 11% by weight or only 2% by volume of adhesive were added. Probably, the adhesive is partly absorbed by the porous light granulate into its interior where it is not only useless but also harmful, for example with regard to the retention volume and density.
the density of the formed body is slightly above the bulk weight of the light granulate.
the porosity is substantially retained and therefore the retention volume and the water-permeability.
the significantly smaller adhesive fraction entails lower costs.
the small adhesive fraction is the basis for the flame-resistance.
despite the small adhesive fraction, the strength of the formed bodies remains at the same level as that of the formed bodies made of non-hydrophobised light granulate. Thus, the adhesion is so firm that 100% cohesion failure occurred in the foam glass.

Because of the many positive properties, the formed bodies according to the invention can also be used in many ways, for example as acoustic panels, in particular when they are coated with a silicate coating, as furniture panels, in particular for worktops, as panels for electrical appliances such as refrigerators, as a door filling and to produce diverse sandwich elements and for sound protection.

The invention will be described in detail below by

### EMBODIMENTS

I. Hydrophobising with Linseed Oil
A) Starting Products for Producing Panels with a Thickness of 40 mm:
a) light granulate: round granulate made of foam glass PORAVER® from the company Dennert Poraver GmbH with a grain size of 4 to 8 mm,
b) hydrophobising agent: linseed oil,
c) binding agent: 2-component polyurethane adhesive Macroplast UK 8614 and hardener CR 4300 from the company Henkel.

### B) Producing the Panels:

a) the quantities of linseed oil given in the following Table 1 were stirred into the given quantities of light granulate, specifically with a paddle stirrer at 250 rpm within 5 minutes at room temperature.
b) 100 parts by weight Macroplast UK 8614 and 38 parts by weight hardener CR 4300 were homogeneously mixed and these adhesive mixtures were mixed in the given quantities into the hydrophobised light granulate, specifically with a paddle mixer at 250 rpm within 5 minutes at room temperature.
c) this mixture of light granulate, linseed oil and adhesive was poured into a mould having the dimensions 400×400×40 mm, so that 5 mm projected over the height of the formed body, and then compressed with a cover plate at a low pressure of 0.5 kg/cm².
d) After hardening in 24 hours at 20° C., the panel was demoulded.

### C) Investigating the Panels:

The panel of Example 1 according to Table 1 is according to the invention but that of Example 2 is not. The density was determined by weighing and measuring a cuboid. That and the flexural strength are practically the same for the panel according to the invention and not according to the invention, even rather better in the panel according to the invention.

### D) Result:

Despite increasing the adhesive quantity by 50% from 200 to 300 g, the strength was not increased. In other words, by hydrophobising with linseed oil, the adhesive content can be significantly reduced without the strength level worsening. Therefore, the costs for the starting materials are significantly reduced as linseed oil is significantly cheaper than the binding agent.

TABLE 1

| | Example 1 | | Example 2 | |
|---|---|---|---|---|
| | Quantity | | Quantity | |
| | in g | % by weight | in g | % by weight |
| Starting materials | | | | |
| Light granulate | 1500 | 84.5 | 1500 | 83.3 |
| Linseed oil | 75 | 4.2 | 0 | 0 |
| Binding agent | 200 | 11.3 | 300 | 16.7 |
| Total quantity | 1775 | 100 | 1800 | 100 |
| Properties | | | | |
| Density | 225 | kg/m³ | 230 | kg/m³ |
| Flexural strength | 0.49 | N/mm² | 0.47 | N/mm² |

II. Formed Body with a Small Quantity of Binding Agent and with Hardened Linseed Oil

### A) Starting Products for Producing Panels:

As in Example I with the quantity details in the following Table 2.

7% by weight of binding agent additive means 1.4% by volume binding agent in the panel.

### B) Production of the Panels:

analogous to the production in Example I.

The linseed oil was either added directly before the binding agent or 12 months beforehand to the light granulate and then stored in conventional room conditions.

### C) Investigation of the Panels

The panel according to Example 3 is not according to the invention and those according to Example 4a), b) and c) are according to the invention. As can be inferred from Table 2, the densities at about 225 kg/m³ are practically the same. The flexural strength of the panels according to the invention at 0.28, 0.34 and 0.44 N/mm² was clearly above that of the one not according to the invention at 0.17 N/mm².

### D) Result

Despite the reduction in the quantity of adhesive from 15 to 7% by weight—see Example 4c) and 4a)—a very good flexural strength was achieved.

This does not only result in a reduction in the panel costs, but also allows better flame-resistance to be expected. The comparison of Example 4a) and 4b) shows that a previous hardening of the linseed oil is also possible.

TABLE 2

| | Example 3 | Example 4a | Example 4b | Example 4c |
|---|---|---|---|---|
| Starting materials | | | | |
| Linseed oil | 0% by | 4% by | 4% by weight | 4% by |
| | weight | weight | stored for 1 | weight |
| | | | year | |
| Binding agent | 7 | 7 | 7 | 15 |
| Light granulate | 93 | 89 | 89 | 81 |
| Total quantity | 100 | 100 | 100 | 100 |
| Properties | | | | |
| Density | 223 | 225 | 226 | 225 |
| | kg/m³ | kg/m³ | kg/m³ | kg/m³ |
| Flexural strength | 0.17 | 0.34 | 0.28 | 0.44 |
| | N/mm² | N/mm² | N/mm² | N/mm² |

### III. Influence of the Hot Hardening

40 mm thick panels were produced analogously to Example I with the production conditions and the properties according to the following Table 3 from the light granulate and binding agent given in Example I. The pressing temperature was given.

The investigations show that in the hot hardening, panels with higher strength were obtained in a substantially shorter time despite the lower adhesive fraction.

TABLE 3

| | Example 5 | | Example 6 | |
|---|---|---|---|---|
| Production | | | | |
| Weight fraction | 15 | | 10 | |
| of 2-component | | | | |
| polyurethane | | | | |
| adhesive in % | | | | |
| Hardening at ° C. | RT | | 200 | |
| Hardening period | 24 hours | | 4 minutes | |
| Properties | | | | |
| Density | 225 | kg/m³ | 222 | kg/m³ |
| Flexural strength | 0.44 | N/mm² | 0.5 | N/mm² |

1-16. (canceled)

17. An open-pore formed body based on inorganic, partially open-pore light granulates based on at least one material from the group of alkali silicates, alkali-alkaline earth silicates, aluminosilicates, borosilicates, and variants in the ternary system CaO—SiO₂—Al₂O₃ in combination with additional metal oxides such as TiO₂ FeO₃ Mn₂O₃, and with a bulk density of 0.10 to 0.60 kg/dm³ measured according to DIN EN 1097-3, wherein the light granulate is provided with a hydrophobised surface and bound with an organic binding agent to form the formed body.

18. A formed body according to claim 17, wherein the light granulate is round and has a grain size of between 0.01 and 30 mm.

19. A formed body according to claim 17, wherein the light granulate is round and has a grain size of between 0.2 and 8 mm.

20. A formed body according to claim 17, wherein the light granulate has a bulk density of 0.15 to 0.35 kg/dm³, measured according to DIN EN 1097-3.

21. A formed body according to claim 17, wherein the light granulate is superficially hydrophobised with a drying oil.

22. A formed body according claim 17, wherein the light granulate is superficially hydrophobised with one of the group of linseed oil and other singly or multiply unsaturated oils such as wood oil, caster oil, fish oil, tall oil, soya bean oil, sunflower oil, rapeseed oil and safflower oil.

23. A formed body according to claim 17, wherein the organic binding agent is a two-component polyurethane adhesive, based on
a) at least one polyhydroxy polyether in the molecular weight range of 60 to 10000 with 2 to 10 hydroxyl groups per molecule, and on
b) at least one multivalent aromatic and aliphatic isocyanate.

24. A formed body according to claim 17, wherein the at least one multivalent aromatic and aliphatic isocyanate comprises an average of 2 to at most 4 NCO groups per molecule.

25. formed body according to claim 17, wherein it has a two-component polyurethane adhesive as the organic binding agent.

26. A formed body according to claim 17, wherein it has a two-component polyurethane adhesive as the organic binding agent with the following composition:
a) 10 to 98% by weight of at least one oleochemical polyol,
b) 1 to 50% by weight of at least one diol with a molecular weight of 60 to 2000 g/mol,
c) 1 to 10% by weight of at least one trivalent, tetravalent or pentavalent polyol with a molecular weight of 90 to 750 g/mol,
d) 0 to 75% by weight of auxiliaries, the % by weight relating as a whole to the components a to d, and
e) at least one polyisocyanate, the NCO/OH ratio of the isocyanates to the polyols being 1.0 to 2.0:1.

27. A formed body according to claim 17, wherein the organic binding agent in the formed body is contained at less than 50% by weight based on the granulate.

28. A formed body according to claim 17, wherein the organic binding agent in the formed body is contained in the range from 5 to 20% by weight based on the granulate.

29. A formed body according to claim 17, wherein it is provided, at least partially and at least on one side on its surface, with at least one of another material and one of a foil and a sheet based on an organic plastics material, such as melamine resin, and an inorganic material, such as one of a silicate fine coating and aluminium.

30. A formed body according to claim 17, wherein it is provided, at least partially and at least on one side on its surface, with at least one of a fibre cement layer, an HPL panel (High Pressure Laminate), a CPL panel (Continuous Pressure Laminate), an HDF panel (High-Density Fibre panel), an MDF panel (Medium-Density Fibre panel), a flexible laminating material such as one of textile and paper.

31. A formed body according to claim 17, wherein it has a retention volume in the range from 20 to 70%.

32. A formed body according to claim 17, wherein it additionally contains a flame retardant.

33. A method for producing formed bodies based on inorganic, partially open-pore light granulates based on at least one material from the group of alkali silicates, alkali-alkaline earth silicates, aluminosilicates, borosilicates, and variants in the ternary system CaO—SiO₂—Al₂O₃ in combination with additional metal oxides such as TiO₂ FeO₃ Mn₂O₃, and with a bulk density of 0.10 to 0.60 kg/dm³ measured according to DIN EN 1097-3, wherein the light granulate is provided with a hydrophobised surface and bound with an organic binding agent to form the formed body, wherein
a) the inorganic light granulate is hydrophobised,
b) the hydrophobised light granulate is mixed with the organic binding agent,
c) the granulate/binding agent mixture is shaped and compressed,
d) the compressed granulate/binding agent is hardened and
e) the hardened granulate/binding agent is demoulded.

34. A method according to claim 33, wherein the individual components of the organic binding agent are mixed with the hydrophobised granulate, specifically in the following order: polyols, polyisocyanates and auxiliaries.

35. A method according to claim 33, wherein the organic binding agent has a viscosity of 1000 to 20 000 mPas at the application temperature measured according to EN ISO 2555.

36. A method according to claim 33, wherein the granulate/binding agent mixture is placed in non-closed mouldings and the uniform filling is assisted by at least one of shaking, vibration and pressure.

37. A method according to claim 33, wherein the light granulate is successively mixed with the hydrophobising agent for hydrophobising in a mixing device, the organic binding agent is then supplied and the granulate/binding agent mixture is continuously pressed for shaping and compression in a continuous press.

38. A method according to claim 33, wherein the hardening takes place either without heating at room temperature or above 60 and up to 250° C. pressing temperature.

39. A method according to claim 33, wherein the hydrophobised light granulate is mixed with one of the group of the binding agent mixture and with the individual components of the organic binding agent and optionally with auxiliaries.

40. A method according to claim 36, wherein the pressure is exerted by rollers using conventional commercial release agents for polyurethane adhesives.

41. A method according to claim 37, wherein the mixing device is a mixing extruder.
